(19) United States
(12) Patent Application Publication
(10) Pub. No.: US 2008/0029520 A1
(43) Pub. Date: Feb. 7, 2008

(54) Sealable Paint Containment Apparatus with Handle Rest

(76) Inventor: Billy Ray Hucks, Columbia, SC (US)

Correspondence Address: CALHOUN "REB" THOMAS, III, 1201 MAIN STREET, SUITE 1750, COLUMBIA, SC, 29201, US

(21) Appl. No.: 11/834,056

(22) Filed: Aug. 6, 2007

Related U.S. Application Data
(60) Provisional application No. 60/821,636, filed on Aug. 7, 2006.

(51) Int. Cl. B05C 21/00; B65D 81/24

(52) U.S. Cl. 220/570; 206/209

(57) ABSTRACT

This invention relates to a paint roller tray with a hinged lid that, when closed, forms a seal in order to protect the contents of the tray. The interior of the tray includes a handle rest for supporting the handle of a paint roller when the tray is stored or otherwise not in active use. The handle rest maintains the roller handle above the level of the paint while both the roller on the drain field and paint in the reservoir remain sealed from the exterior of the tray. Further, the invention includes grooves on the lid and corresponding protrusions and tabs on the bottom that facilitate stacking of multiple paint trays.

### RELATED APPLICATIONS

This application claims the benefit of prior filed US Provisional Application having Ser. No. 60/821,636 filed on Aug. 7, 2006.

### FEDERALLY SPONSORED RESEARCH OR DEVELOPMENT

Not applicable.

### REFERENCED OR INCORPORATED MATERIAL

Not applicable.

### BACKGROUND OF INVENTION

The art of paint application whether via brush or roller is quite old. The practitioners in the art are both professionals and non-professionals such as homeowners and hobbyists. In either case, they often employ a variety of tools towards a given painting job. Specifically, when rollers are employed as a means of paint application, it is common for the painter to use both large rollers, for broad surfaces, and small rollers, for narrower surfaces such as trim work.

When using rollers of either type, it is very common for the painter to use a paint or roller tray to facilitate the application of the paint onto the roller head. These trays often have some sort of paint reservoir or paint well and an inclined path along which the paint is applied to the roller. With these type paint trays, when a given painting task is begun, the painter pours paint into the reservoir of the tray and then applies that paint to the roller head utilizing the inclined tray.

Typically a painting job can be a lengthy process whether undertaken professionally or non-professionally. As such, there are often breaks in the painting process where the painters may change shifts, take lunch and other breaks, alternate among job sites, or otherwise temporarily halt the painting process. These breaks can be as short as a few minutes or as long as a week or more. Under the current state of the art, when such breaks occur, the painters often must take additional steps to preserve their equipment.

These additional steps are necessitated because of the properties of paint. When paint is left exposed to the ambient air for extended periods of time, it can thicken or even dry to the point where it is unsuitable for use. Further, any applicators similarly left exposed will experience the drying of residual paint left on the application surfaces. In short, paint left in an open tray and or a roller or brush will create considerable waste and impose a correspondent cost on the painter.

Unfortunately, the alternatives available to the painter under the current state of the art do not offer significant paths to avoiding such waste and potential costs. First, the painter could undertake to thoroughly clean the tray and roller each time before a halt in painting activities. Such a cessation requires the painter to treat his equipment with various solvents and the like in order to remove all paint that may dry during the intervening time. This activity obviously costs the painter much time and results in wasted paint and solvents. Moreover, the environmental consequences and related disposals add additional hazards to the painter's task.

A second alternative available is to utilize a paint container that has a closeable lid. Unfortunately, containers lids often do not fit securely or are otherwise detached from the tray and are not easily located when the painter wishes to seal the tray. Further, many containers that do offer some form of sealing do not offer adequate sealed protection for the roller. Moreover, even if the roller is left inside the tray, the handle often has no other option than to also rest haphazardly against the side of the tray or, worse yet, directly in the paint itself.

The same wasteful situation involved with halts in painting also arises when color changes are desired. For instance when a painter is required to use different colors in a given painting job, the painter generally must clean the tray and rollers for each color type or else risk the paint drying out in one tray while other trays containing alternate colors are used. Moreover, when a painter utilizes multiple trays for multiple colors, there are often problems arising from a lack of places to store multitudes of paint trays.

Thus, there exists a need in the art for a paint tray that can effectively seal the paint and roller or brush contained therein allowing the painter to simply and efficiently halt painting operations while at the same time facilitating the efficient storage of multiple trays and their associated rollers and brushes.

### SUMMARY OF THE INVENTION

In light of the above background, the present invention is a sealable paint containment apparatus that facilitates both the painting process and allows for interim stoppages in work without the need to clean the equipment to avoid thickening and drying of residual paint. Moreover, the invention contemplates a stacking feature whereby multiple trays can be utilized and temporarily stored for ready use as desired by the painter. The invention contemplates a variety of different size trays to correspond to different size rollers or brushes. Additionally, in the preferred embodiment, the tray is made of transparent or semi-transparent material so that the painter can view the color of paint contained therein without having to first remove the sealed lid for inspection.

The paint tray of the present invention is made of lightweight plastic, has traditional paint drainage grid and reservoir, has a sealable lid, and affords the internal placement and storage during non-use of a common paint roller or brush. Whereas, under the prior art when a painter wished to stop painting the painter had to place the handle of the roller precariously on the edge of the paint tray, under the present invention, the painter need simply place the roller or brush on the drain surface and the handle of said roller on an internal handle rest and close the sealable lid. In this way, the apparatus facilitates not only the active painting uses as with traditional paint trays, but also the interim storage necessitated by work stoppages. Such use is facilitated by the unique non-use handle rest located opposite the paint drain. Therefore, by being able to effectively store the paint and preserve the roller or brush in the tray container, the painter is able to stop and resume painting without worrying about the roller and paint drying out.

The ability to stop and resume painting activities without the additional step of interim clean up results in cost saving to the painter. This savings therefore positively impacts the painter by way of decreased job time and decreased disposal costs.

Additionally, the lid in the preferred embodiment is hingedly attached to the lower portion of the paint tray. This improvement allows the lid to be collocated with the tray at all times so that the lid is not misplaced when the painter wishes to seal the tray for later use. This further provides for quick and efficient sealing of the paint and paint equipment.

Finally, the tray and lid combination is designed to be stackable such that grooves on the lid of one unit mesh with protrusions or tabs on the bottom of another unit. This stacking ability allows multiple trays to be stacked in succession thereby facilitating storage of multiple units containing different color/tray/roller/brush combinations as required by the painter. The stacking feature further contemplates unit displays, including the paint handle, and roller, facilitating identification of its unique purpose in the marketplace.

### BRIEF DESCRIPTION OF THE SEVERAL VIEWS OF THE DRAWINGS

FIG. 1 is a perspective view showing the paint tray with the lid (10) closed.

FIG. 2 is a perspective view showing the paint tray with the lid (10) closed and highlighting a paint roller securely stored therein.

FIG. 3 is a perspective view showing the paint tray with the lid (10) open and showing a paint roller resting its handle (30) on the non-use handle rest (25) and a roller head (31) resting on the inclined drain field (22).

FIG. 4 is a perspective view showing the paint tray with the lid (10) open.

FIG. 5 is a top view showing a paint roller resting its handle (30) on the non-use handle rest (25) and its roller head (31) on the inclined drain field (22).

FIG. 6 is a bottom view of the paint tray.

FIG. 7 is a side view showing the paint tray with the lid (10) closed and highlighting a paint roller securely stored therein.

FIG. 8 is an end side view showing the paint tray with the lid (10) closed and highlighting a paint roller with its handle (30) resting on the non-use handle rest (25).

FIG. 9 is an end side view showing the paint tray with the lid (10) closed and highlighting a paint roller with its roller head (31) resting on the inclined drain field (22).

FIG. 10 is a side view showing multiple units stacked one on another and highlighting the internally stored paint roller which has its handle (30) resting on the non-use handle rest (25).

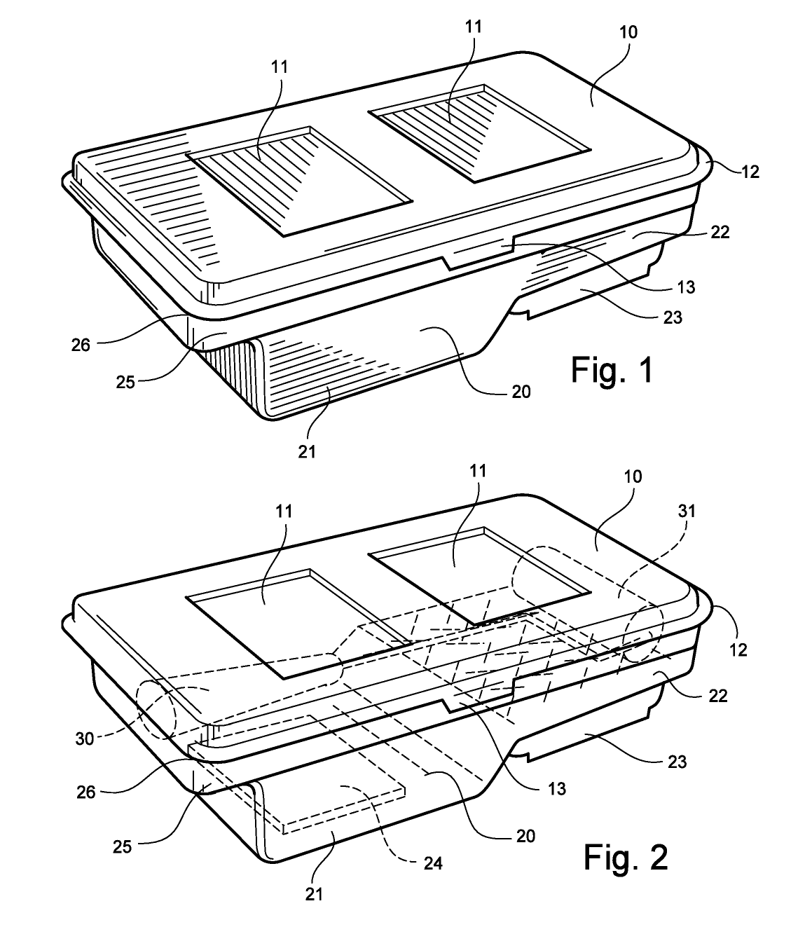

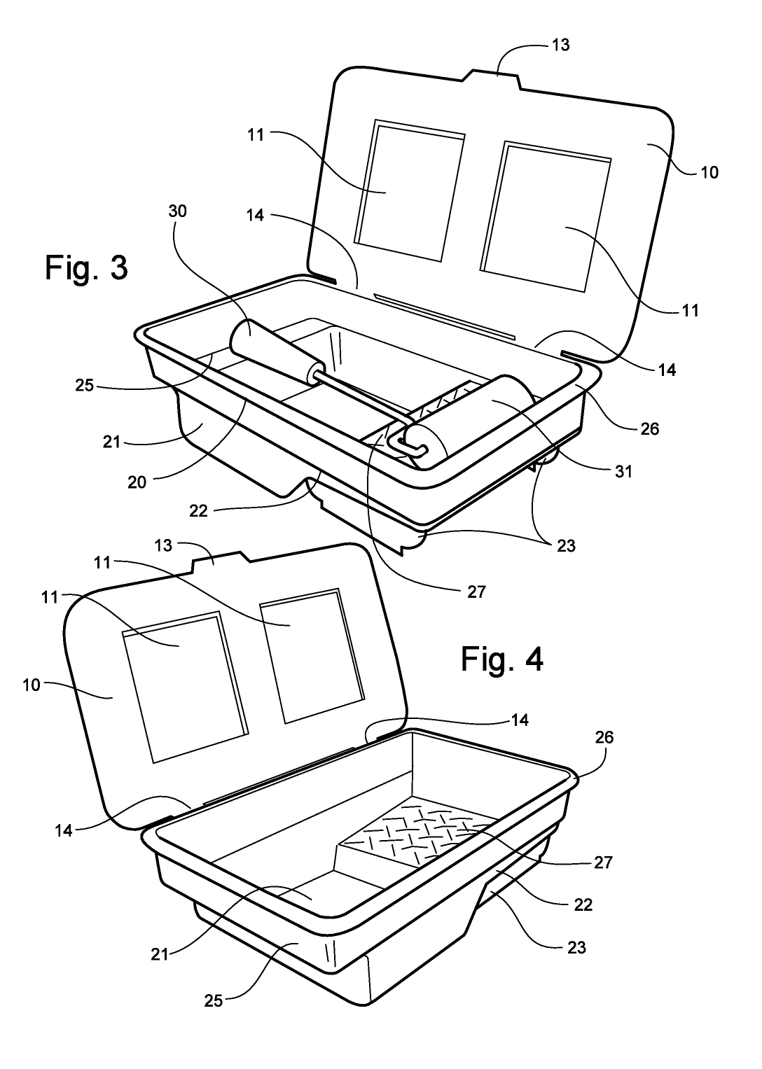

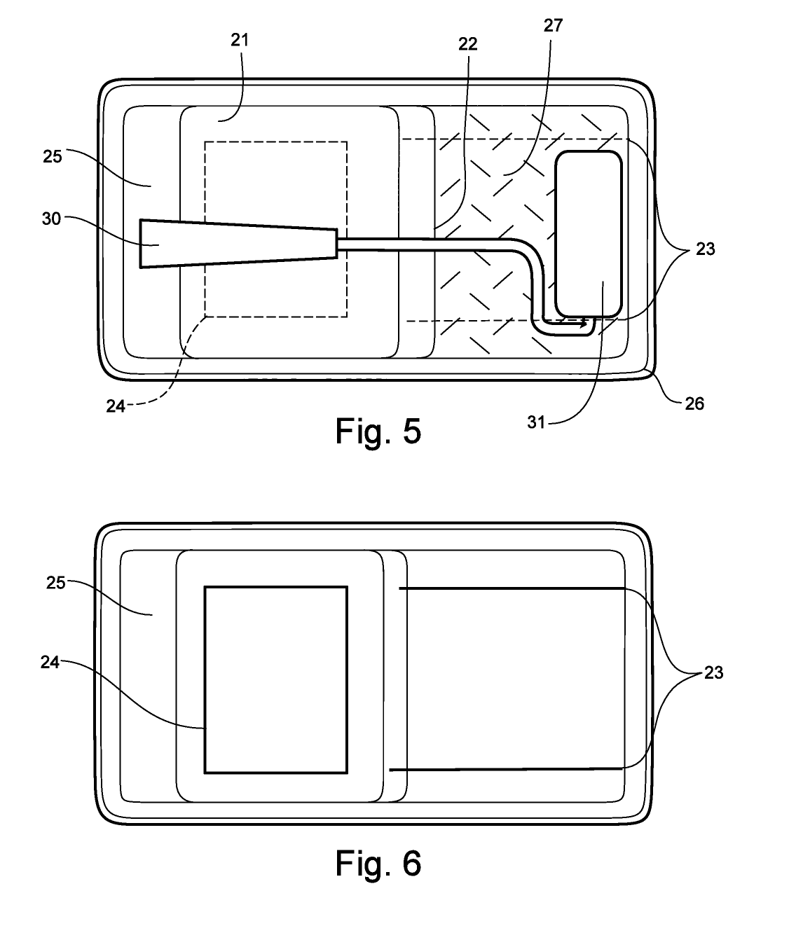

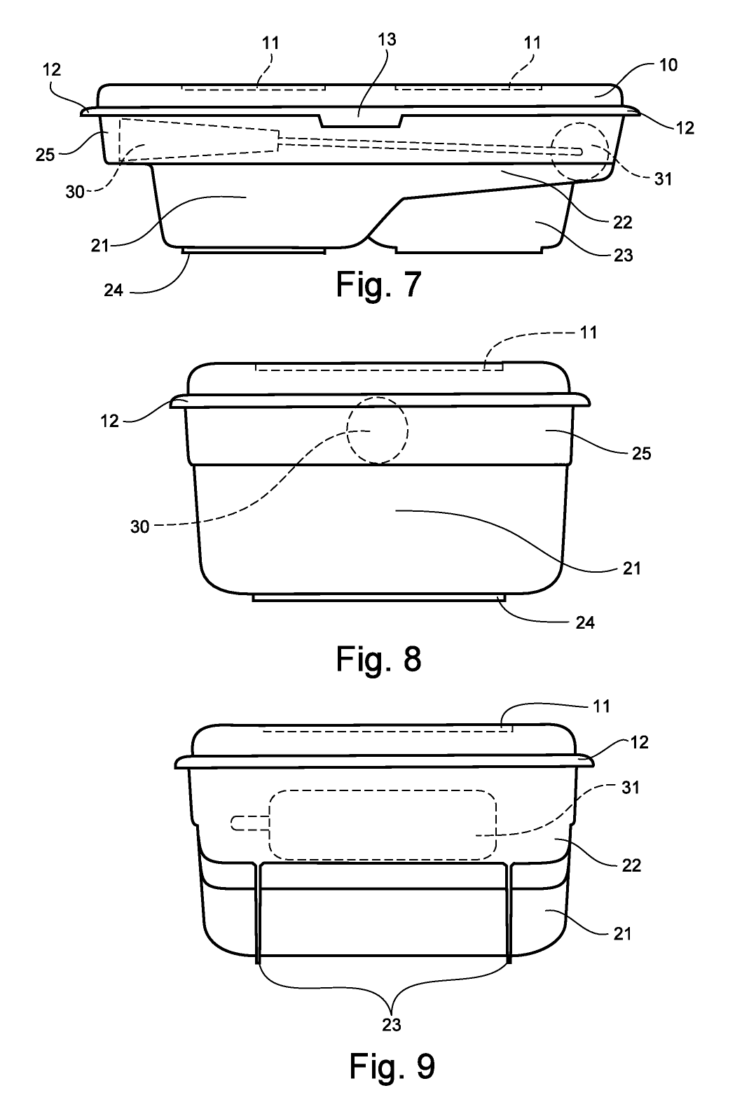

### DETAILED DESCRIPTION

It is to be understood by a person having ordinary skill in the art that the present discussion is a description of exemplary embodiments only, and is not intended as limiting the broader aspects of the present invention. The following example is provided to further illustrate the invention and is not to be construed to unduly limit the scope of the invention.

The preferred embodiment contemplates an improved paint containment unit that has both a lid (10) and a tray (20). Both the lid (10) and the tray (20) are generally rectangular in shape. In the preferred embodiment, the lid (10) is hingedly attached to the tray (20) via a hinge connection (14) and operates in two positions, namely, open when the paint tray is actively being used and closed when the lid (10) is securing the contents of the unit and limiting drying of the paint, paint roller, or brush.

The lid (10) has grooves (11) molded into its top surface in order to facilitate stacking with other units when the lid (10) is in the closed position. In the preferred embodiment, the grooves (11) are rectangular in shape though any shape would be adequate as long as it facilitates stacking with correspondent indentations (23 & 24) on the bottom of the tray (20).

Importantly, the lid (10) and the tray (20) are sealed when the unit is in the closed position. In the preferred embodiment, the lid (10) has a concave shaped channel (12) that meshes with the opposite convex shaped lip or rim (26) of the tray in order to seal the contents of the unit and, thereby, better preserve the contents. The lid (10) also has a clasp (13) disposed thereon for the purpose of securing the lid (10) in the closed position. The clasp (13) attaches to the tray (20) when the lid (10) is closed.

Corresponding to the concave channel (12) on the lid (10), the tray has a convex lip (26) located on its top periphery that meshes with the channel (12) to form a seal.

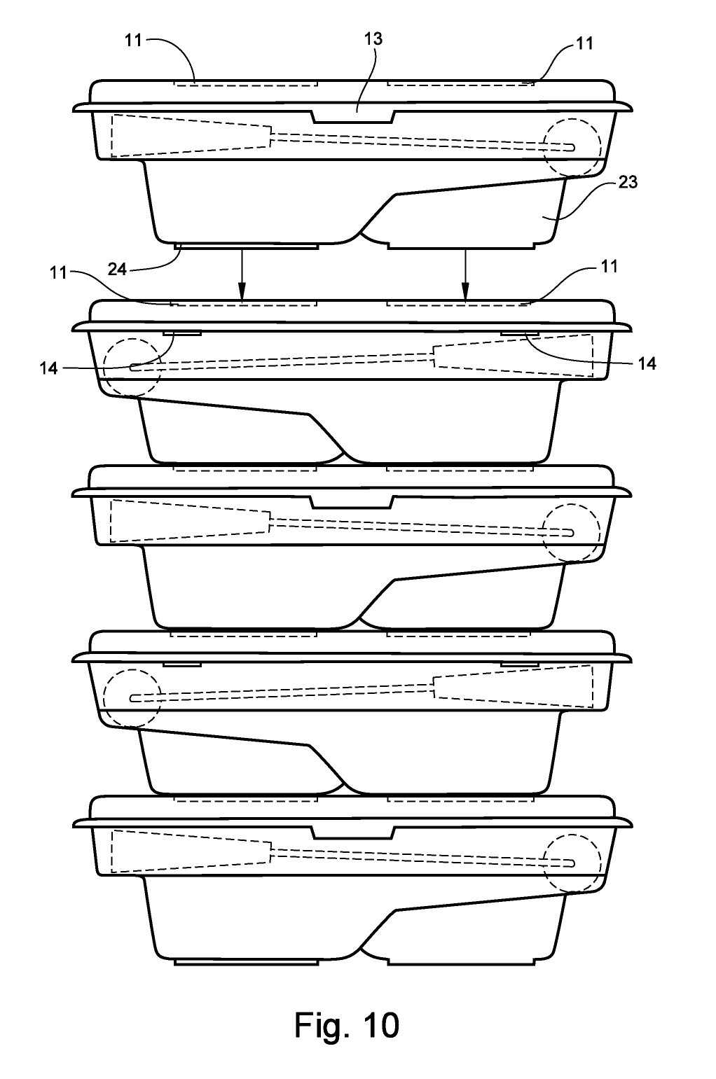

The tray has three portions, the reservoir portion (21), the drain portion (22), and the nonuse handle rest portion (25). The drain portion (22) has an inclined drainage field (22) that slopes toward the paint well or reservoir (21). The drainage field (22) has a grid (27) disposed thereon for effecting measured paint transfer to the roller head (3 1). Below the drainage field (22) and external to the tray (20) are located two parallel protruding tabs (23) designed to mesh with grooves (11) located on the lid (10) of a second unit for the purposes of stacking multiple units one upon the other as illustrated in FIG. 10. The parallel protruding tabs (23) also provide stability when the unit is resting on a flat surface rather than on another unit as with stacking.

The non-use handle rest portion (25) is adjacent to the paint well (21) and is opposite the drain field (22). The internal non-use handle rest (25) is an important element that allows a roller or paint brush to be placed inside the tray (20) and stored when the lid (10) is in the closed position. When the head of the roller (31) or brush is placed on the drainage field (22), the handle (30) securely rests on the non-use handle rest (25). Further, the exterior portion of the non-use handle rest (25) can also serve as a handle and easy grip portion for the entire paint tray unit when the user wishes to move the unit. When used in this manner, the painter grips the exterior portion of unit around the non-use handle rest (25) that has been molded into the unit.

The reservoir portion (21) comprises the paint well (or reservoir) (21) and the external protrusions (24). The paint well (21) is the reservoir in which paint is contained in the tray (21). When a painter begins a painting job, he or she pours paint into the reservoir (21). As the roller head (31) is used, excess and residual paint located on the drainage field (22) returns via the incline to the paint well (21). Further, when the lid (10) is in the closed position, and the unit is in storage, the paint well (21) acts as a storage vessel.

There are also protrusions (24) located on the bottom of the reservoir portion, external to the tray. These protrusions likewise mesh with the grooves (11) located on the lid (10) of another unit in order to facilitate the stacking of multiple units as illustrated in FIG. 10.

What is claimed is:

1. A paint containment unit comprising a lid operating in an open or a closed position, a tray hingedly attached to said lid, a nonuse handle rest integrated within said tray, and a means of sealing said tray and said lid.

2. The paint containment unit of claim 1 wherein: said lid further comprises a plurality of stacking grooves; said tray further comprises a reservoir, a drain field, a plurality of bottom protrusions disposed on said reservoir, and a pair of parallel protruding tabs disposed on said drain field; and said means of sealing the tray and the lid is a lip-channel seal.

3. The paint containment unit of claim 1 wherein said paint containment unit is made of plastic.

4. The paint containment unit of claim 3 wherein said paint containment unit is rigid and reusable for containing solvent and water based paints.

5. The paint containment unit of claim 3 wherein said paint containment unit is disposable for containing water based paints.

6. The paint containment unit of claim 1 wherein said lid further comprises a clasp for securing said lid to said tray.

7. The paint containment unit of claim 2 wherein said drain field has an inclined orientation and has a grid disposed on its interior surface.

8. The paint containment unit of claim 2 wherein said lip-channel seal comprises a concave channel disposed on said lid and a convex lip disposed on said tray.

9. The paint containment unit of claim 2 wherein said lip-channel seal comprises a convex lip disposed on said lid and a concave channel disposed on said tray.

10. A paint containment system comprising a plurality of stackable paint containment units wherein each stackable paint containment unit of said plurality of stackable paint containment units further comprises: a lid further comprising a plurality of stacking grooves, a clasp, and a concave perimeter channel attached to the lower perimeter of said lid; and a tray, hingedly attached to said lid, further comprising a reservoir portion, a drain field portion, a nonuse handle rest portion, a convex perimeter lip attached to the upper perimeter of said tray, a pair of protruding tabs attached to the lower side of the drain field portion, and a plurality of bottom protrusions attached to the lower side of the reservoir portion.

11. The paint containment system of claim 10 wherein said drain field slopes on an incline from the end of the tray opposite the nonuse handle rest portion of the tray to the reservoir portion of the tray and further comprises a grid.

12. The paint containment system of claim 10 wherein each stackable paint containment unit of said plurality of stackable paint containment units is made of plastic.

13. A paint containment unit having a generally rectangular shape, being made of plastic, and comprising: a lid operating in an open or a closed position; a tray hingedly attached to said lid, where said tray further comprises a reservoir, a drain field, and a interior nonuse handle rest; and a means of sealing said lid and tray using an insertion edge and a receiving groove.

14. The paint containment unit of claim 13 wherein the upper portion of the lid, when viewed in the closed position, has a plurality of indentations and the lower portion of the tray has a plurality of protrusions that correspond in shape and number to the indentations on the lid.

15. The paint containment unit of claim 14 wherein said means of sealing said lid and tray further comprises a clasp for securing said lid to said tray and said insertion edge and said receiving groove for generally air-tight seal for the contents of the unit.

16. The paint containment unit of claim 15 wherein the protrusions descending from the underside of the drain field portion of the tray and the smaller protrusions on the underside of the reservoir portion of the tray are disposed to just fit within the indentations on the lid of a second unit so as to facilitate secure stacking of the units.

17. The paint containment unit of claim 16 wherein the protrusions on the underside of the reservoir form a generally rectangular shape that is slightly smaller than the generally rectangular shaped indentations on the lid and the longer protrusions descending from the underside of the inclined drain field are two fins that are slightly shorter than the corresponding sides of said lid indentations.

18. The paint containment unit of claim 17 wherein the entire unit is sized to match standard sizes of rollers and brushes regularly used in the painting industry.
